(19) United States
(12) Patent Application Publication
(10) Pub. No.: US 2011/0004465 A1
(43) Pub. Date: Jan. 6, 2011

(54) Computation and Analysis of Significant Themes

(75) Inventors: Stuart J. Rose, Richland, WA (US); Wendy E. Cowley, Richland, WA (US); Vernon L. Crow, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/568,365

(22) Filed: Sep. 28, 2009

Related U.S. Application Data
(60) Provisional application No. 61/222,737, filed on Jul. 2, 2009.

(51) Int. Cl. G06F 17/27

(52) U.S. Cl. 704/9

(57) ABSTRACT

Systems and computer-implemented processes for computation and analysis of significant themes in a corpus of documents. The computation and analysis of significant themes can be executed on a processor and involves generating a lexical unit document association (LUDA) vector for each lexical unit that has been provided and quantifying similarities between each unique pair of lexical units. The LUDA vector characterizes a measure of association between its corresponding lexical unit and documents in the corpus. The lexical units can then be grouped into clusters such that each cluster contains a set of lexical units that are most similar as determined by the LUDA vectors and a predetermined clustering threshold.

### PRIORITY

This invention claims priority from U.S. Provisional Patent Application No. 61/222,737, entitled “Feature Extraction Methods and Apparatus for Information Retrieval and Analysis,” filed Jul. 2, 2009.

### STATEMENT REGARDING FEDERALLY SPONSORED RESEARCH OR DEVELOPMENT

This invention was made with Government support under Contract DE-ACO576RL01830 awarded by the U.S. Department of Energy. The Government has certain rights in the invention.

### BACKGROUND

A problem today for many individuals, particularly practitioners in the disciplines involving information analysis, is the scarcity of time and/or resources to review the large volumes of information that are available and potentially relevant. Effective and timely use of such large amounts of information is often impossible using traditional approaches, such as lists, tables, and simple graphs. Tools that can help individuals automatically identify and/or understand the themes, topics, and/or trends within a body of information are useful and necessary for handling these large volumes of information. Many traditional text analysis techniques focus on selecting features that distinguish documents within a document corpus. However, these techniques may fail to select features that characterize or describe the majority or a minor subset of documents within the corpus. Furthermore, when the information is streaming and/or updated over time, the corpus is dynamic and can change significantly over time. Therefore, most of the current tools are limited in that they only allow information consumers to interact with snapshots of an information space that is often times continually changing.

Since most information sources deliver information streams, such as news syndicates and information services, and/or provide a variety of mechanisms for feeding the latest information by region, subject, and/or by user-defined search interests, when using traditional text analysis tools, new information that arrives can eclipse prior information. As a result, temporal context is typically lost with employing corpus-oriented text analysis tools that do not accommodate dynamic corpora. Accurately identifying and intelligently describing change in an information space requires a context that relates new information with old. Accordingly, a need exists for systems and computer-implemented processes for computation and analysis of significant themes within a corpus of documents, particularly when the corpus is dynamic and changes over time.

### SUMMARY

Aspects of the present invention provide systems and computer-implemented processes for determining coherent clusters of individual lexical units, such as keywords, keyphrases and other document features. These clusters embody distinct themes within a corpus of documents. Furthermore, some embodiments can provide processes and systems that enable identification and tracking of related themes across time within a dynamic corpus of documents. The grouping of documents into themes through their essential content, such as lexical units, can enable exploration of associations between documents independently of a static and/or pre-defined corpus.

As used herein, lexical units can refer to significant words, symbols, numbers, and/or phrases that reflect and/or represent the content of a document. The lexical units can comprise a single term or multiple words and phrases. An exemplary lexical unit can include, but is not limited to, any lexical unit, which can provide a compact summary of a document. Additional examples can include, but are not limited to, entities, query terms, and terms or phrases of interest. The lexical units can be provided by a user, by an external source, by an automated tool that extracts the lexical units from documents, or by a combination of the two.

A theme, as used herein, can refer to a group of lexical units that are predominantly associated with a distinct set of documents in the corpus. A corpus may have multiple themes, each theme relating strongly to a unique, but not necessarily exclusive, set of documents.

Embodiments of the present invention can compute and analyze significant themes within a corpus of documents. The corpus can be maintained in a storage device and/or streamed through communications hardware. Computation and analysis of significant themes can be executed on a processor and comprises generating a lexical unit document association (LUDA) vector for each lexical unit that has been provided and quantifying similarities between each unique pair of lexical units. The LUDA vector characterizes a measure of association between its corresponding lexical unit and documents in the corpus. The lexical units can then be grouped into clusters such that each cluster contains a set of lexical units that are most similar as determined by the LUDA vectors and a predetermined clustering threshold. To each cluster a theme label can be assigned comprising the lexical unit within each cluster that has the greatest measure of association.

In preferred embodiments, the steps of providing lexical units, generating LUDA vectors, quantifying similarities between lexical units, and grouping lexical units into clusters are repeated at pre-defined intervals if the corpus of documents is not static. Accordingly, the present invention can operate on streaming information to extract content from documents as they are received and calculate clusters and themes at defined intervals. The clusters and/or themes calculated at a given interval can be persisted allowing for evaluation of overlap and differences with themes and/or clusters from previous and future intervals.

In some embodiments, the lexical units can be provided after having been automatically extracted them from individual documents within the corpus of documents. In a particular instance, extraction of lexical units from the corpus of documents can comprise parsing words in an individual document by delimiters, stopwords, or both to identify candidate lexical units. Co-occurrences of words within the candidate lexical units are determined and word scores are calculated for each word within the candidate lexical units based on a function of co-occurrence degree, co-occurrence and frequency, or both. A lexical unit score is then calculated for each candidate lexical unit based on a function of word scores for words within the candidate lexical units. Lexical unit scores for each candidate lexical unit can comprise a sum of the word scores for each word within the candidate lexical unit. A portion of the candidate lexical units can then be selected for extraction as actual lexical units based, at least in part, on the candidate lexical units with highest lexical units scores. In some embodiments, a predetermined number, T, of candidate lexical units having the highest lexical unit scores are extracted as the lexical units.

In preferred embodiments, co-occurrences of words are stored within a cooccurrence graph. Furthermore, adjoining candidate lexical units that adjoin one another at least twice in the individual document and in the same order can be joined along with any interior stopwords to create a new candidate lexical unit.

When grouping the lexical units into clusters, the measure of association can be determined by submitting each lexical unit as a query to the corpus of documents and then storing document responses from the queries as the measures. Alternatively, the measure of association can be determined by quantifying frequencies of each lexical unit within each document in the corpus and storing the frequencies as the measures. In yet another embodiment, the measure of association is a function of frequencies of each word within the lexical units within each document in the corpus. In specific instances, the similarities between lexical units can be quantified using Sorenson similarity coefficients of respective LUDA vectors. Alternatively, the similarity between lexical units can be quantified using pointwise mutual information of respective LUDA vectors.

In preferred embodiments, grouping of lexical units comprises applying hierarchical agglomerations clustering to successively join similar pairs of lexical units into a hierarchy. In a specific instance, the hierarchical clustering is Ward's hierarchical clustering, and clusters are defined using a coherence threshold of 0.65.

The corpus of documents can be static or dynamic. A static corpus refers to a more traditional understanding in which the corpus is fixed with respect to content in time. Alternatively, a dynamic corpus can refer to streamed information that is updated periodically, regularly, and/or continuously. Stories, which can refer to a dynamic set of documents that are associated to the same themes across multiple intervals and can emerge from analysis of a dynamic corpus. Stories can span multiple documents in time intervals and can develop, merge, and split as they intersect and overlap with other stories over time.

When operating on a dynamic corpus of documents, embodiments of the present invention can maintain a sliding window over time, removing old documents as time moves onward. The duration of the sliding window can be pre-defined to minimize any problems associated with scalability and the size of the corpus. Since the sliding window can limit how far back in time a user can analyze data, preferred embodiments allows a user to save to a storage device a copy of any current increment of analysis.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 includes a Voice of America news article and automatically extracted lexical units according to embodiments of the present invention.

FIG. 2 is a table comparing assigned topics in the Multi-perspective question answering corpus and themes calculated according to embodiments of the present invention.

FIG. 3 is a table that summarizes the calculated themes for Jan. 12, 1998 Associated Press documents in the TDT-2 Corpus.

FIG. 4 is a visual representation of themes computed according to embodiments of the present invention.

FIG. 5 is a visual representation of themes computed according to embodiments of the present invention.

### DETAILED DESCRIPTION

The following description includes at least the best mode of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Many current text analysis techniques focus on identifying features that distinguish documents from each other within an encompassing document corpus. These techniques may fail to select features that characterize or describe the majority or a minor subset of the corpus. Furthermore, when the information is streaming, the corpus is dynamic and can change significantly over time. Techniques that evaluate documents by discriminating features are only valid for a snapshot in time.

To more accurately characterize documents within a corpus, preferred embodiments of the present invention apply computational methods for characterizing each document individually. Such methods produce information on what a document is about, independent of its current context. Analyzing documents individually also further enables analysis of massive information streams as multiple documents can be analyzed in parallel or across a distributed architecture. In order to extract content that is readily identifiable by users, techniques for automatically extracting lexical units can be applied. Rapid Automatic Keyword Extraction (RAKE) is one such technique that can take a simple set of input parameters to automatically extract keywords as lexical units from a single document. Details regarding RAKE are described in U.S. patent application Ser. No. 12/555,916, filed on Sep. 9, 2009, which details are incorporated herein by reference. Briefly, RAKE is a computer implemented process that parses words in an individual document by delimiters, stopwords, or both to identify lexical units. Co-occurrences of words within the lexical units are determined and word scores are calculated for each word within the lexical units based on a function of co-occurrence degree, co-occurrence and frequency, or both. A lexical unit score is then calculated for each lexical unit based on a function of word scores for words within the lexical units. Lexical unit scores for each lexical unit can comprise a sum of the word scores for each word within the lexical unit. A portion of the lexical units can then be selected for extraction as essential lexical units based, at least in part, on the lexical units with highest lexical unit scores. In some embodiments, a predetermined number, T, of lexical units having the highest lexical unit scores are extracted as the essential lexical units, or keywords.

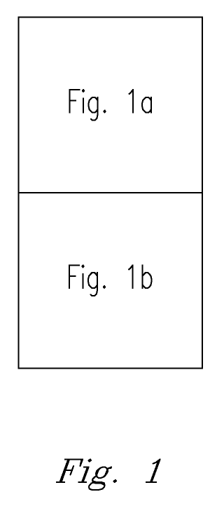

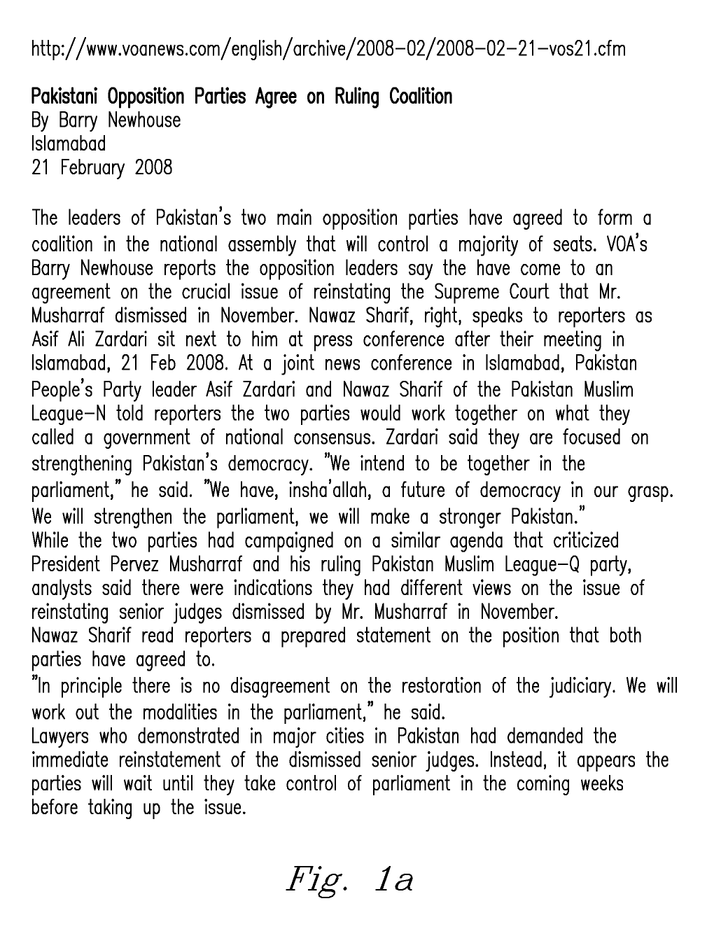

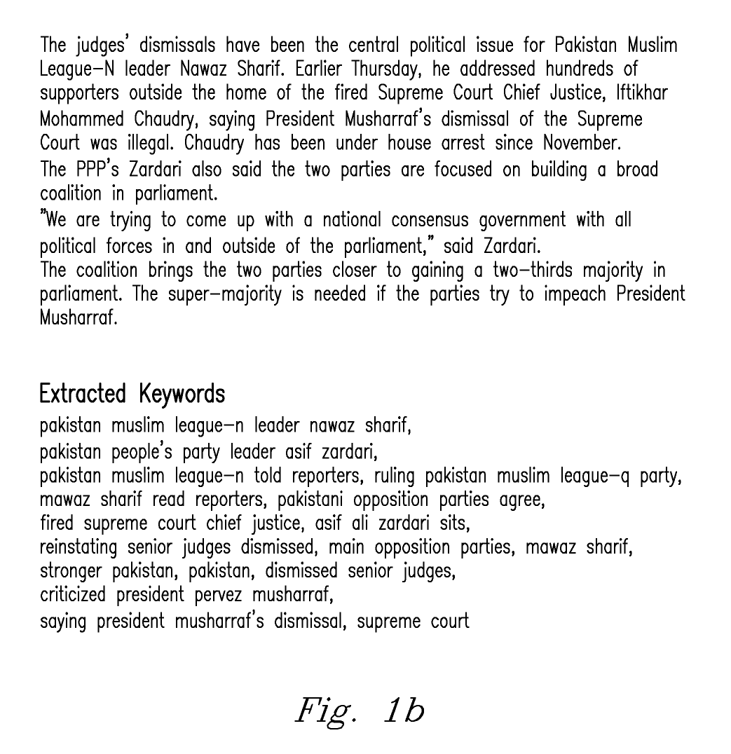

FIG. 1 shows keywords of a news article from Voice of America (VOA) as extracted lexical units. Exemplary lexical units from the (VOA) news article include Pakistan Muslim League-N leader Nawaz Sharif and criticized President Pervez Musharraf.

Keywords (i.e., lexical units), which may comprise one or more words, provide an advantage over other types of signatures as they are readily accessible to a user and can be easily applied to search other information spaces. The value of any particular keyword can be readily evaluated by a user for their particular interests and applied in multiple contexts. Furthermore, the direct correspondence of extracted keywords with the document text improves the accessibility of a user with the system.

For a given corpus, whether static or representing documents within an interval of time, a set of extracted lexical units arc selected and grouped into coherent themes by applying a hierarchical agglomerative clustering algorithm to a lexical unit similarity matrix based on lexical unit document associations in the corpus. Lexical units that are selected for the set can have a higher ratio of extracted document frequency, or the number of documents from which the lexical unit was extracted as a keyword, to total document frequency, or are otherwise considered representative of a set of documents within the corpus.

The association of each lexical unit within this set to documents within the corpus is measured as the document's response to the lexical unit, which is obtained by submitting each lexical unit as a query to a Lucene index populated with documents from the corpus. The query response of each document hit greater than 0.1 is accumulated in the lexical unit's document association vector. Lucene calculates document similarity according to a vector space model. In most cases the number of document hits to a particular lexical unit query is a small subset of the total number of documents in the index. Lexical unit document association vectors typically have fewer entries than there are documents in the corpus and are very heterogeneous.

The similarity between each unique pair of lexical units is calculated as the Sorensen similarity coefficient of the lexical units' respective document association vectors. The Sorensen similarity coefficient is used due to its effectiveness on heterogeneous vectors and is identical to 1.0—Bray-Curtis distance, shown in equation

$${BC}_{ab} = \frac{\sum \vert {a}_{i} - {b}_{i} \vert}{\sum ( {a}_{i} + {b}_{i} )} \qquad Eqn . 1$$

Coherent groups of lexical units can then be calculated by clustering lexical units by their similarity. Because the number of coherent groups may be independent of the number of lexical units extracted, Ward's hierarchical agglomerative clustering algorithm, which does not require a pre-defined number of clusters, can be applied.

Ward's hierarchical clustering begins by assigning each element to its own cluster and then successively joins the two most similar clusters into a new, higher-level, cluster until a single top level cluster is created from the two remaining, least similar, ones. The decision distance ddᵢⱼ between these last two clusters is typically retained as the maximum decision distance ddₘₐₓ for the hierarchy and can be used to evaluate the coherence ccₙ of lower level clusters in the hierarchy as shown in equation (2).

$${cc}_{n} = 1 - \frac{{dd}_{n}}{{dd}_{max}} \qquad Eqn . 2$$

Clusters that have greater internal similarity will have higher coherence. Using a high coherence threshold prevents clusters from including broadly used lexical units such as president that are likely to appear in multiple themes. In preferred embodiments, clusters with a coherence threshold of 0.65 or greater are selected as candidate themes for the corpus.

Each candidate theme comprises lexical units that typically return the same set of documents when applied as a query to the document corpus. These lexical units occur in multiple documents together and may intersect other stories singly or together.

We select the final set of themes for the corpus by assigning documents to their most highly associated theme. The association of a document to a theme is calculated as the sum of the document's associations to lexical units that comprise the theme. After all documents in the corpus have been assigned, we filter out any candidate themes for which no documents have been assigned. Lexical units within each theme are then ranked by their associations to documents assigned within the theme. Hence the top ranked lexical unit for each theme best represents documents assigned to the theme and is used as the theme's label.

### EXAMPLE

### Computation and Analysis of Significant Themes in the Multi-Perspective Question Answering Corpus (MPQA)

The MPQA Corpus consists of 535 news articles provided by the Center for the Extraction and Summarization of Events and Opinions in Text (CERATOPS). Articles in the MPQA Corpus are from 187 different foreign and U.S. news sources and date from June 2001 to May 2002.

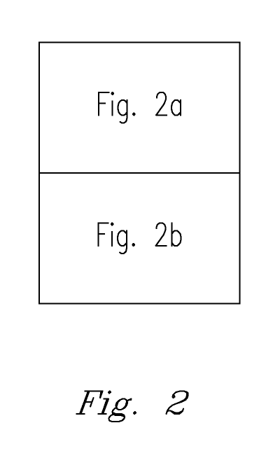

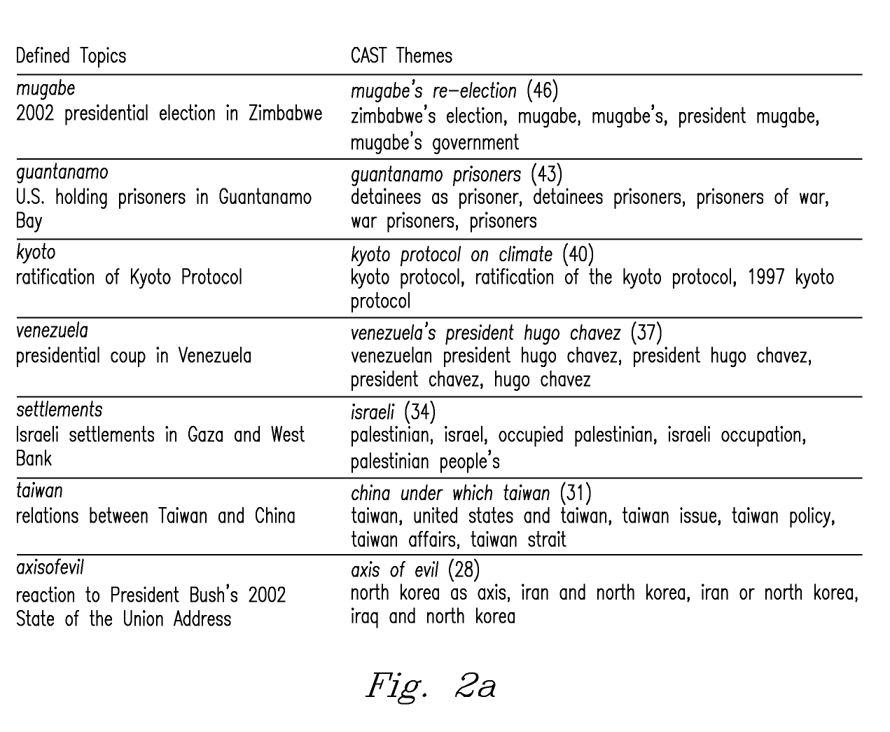

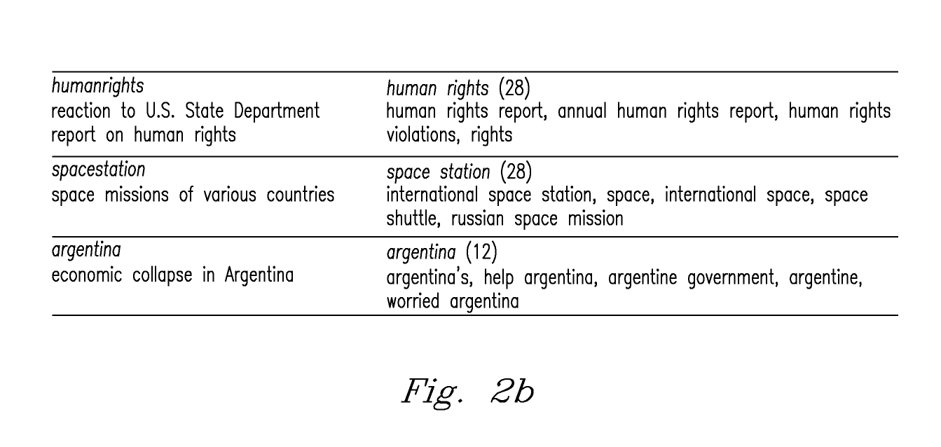

RAKE was applied to extract keywords as lexical units from the title and text fields of documents in the MPQA Corpus. Lexical units that occurred in at least two documents were selected from those that were extracted. Embodiments of the present invention were then applied to compute themes for the corpus. Of the 535 documents in the MPQA Corpus, 327 were assigned to 10 themes which align well with the 10 defined topics for the corpus as shown in FIG. 2. The number of documents that CAST assigned to each theme is shown in parentheses. As defined by CERATOPS:
The majority of the articles are on 10 different topics, but a number of additional articles were randomly selected (more or less) from a larger corpus of 270,000 documents.

The majority of the remaining themes computed in the instant example had fewer than four documents assigned, an expected result given the random selection of the remainder of documents in the MPQA Corpus.

As described elsewhere herein, embodiments of the present invention can operate on streaming information to extract essential content from documents as they are received and to calculate themes at defined time intervals. When the current time interval ends, a set of lexical units is selected from the extracted lexical units and lexical unit document associations are measured for all documents published or received within the current and previous n intervals. Lexical units are clustered into themes according to the similarity of their document associations, and each document occurring over the past n intervals is assigned to the theme for which it has the highest total association.

The set of themes computed for the current interval are persisted along with their member lexical units and document assignments. Overlap with previous and future themes may be evaluated against previous or future intervals by comparing overlap of lexical units and document assignments. Themes that overlap with others across time together relate to the same story.

Repeated co-occurrences of documents within themes computed for multiple distinct intervals are meaningful as they indicate real similarity and relevance of content between those documents for those intervals.

In addition to the expected addition of new documents to an existing story and aging out of documents older than n intervals, it is not uncommon for stories to gain or lose documents to other stories. Documents assigned to the same theme within one interval may be assigned to different themes in the next interval. Defining themes at each interval enables embodiments of the present invention to automatically adapt to future thematic changes and accommodate the reality that stories often intersect, split, and merge.

In order to show the utility, embodiments of the present invention were applied on documents within the Topic Detection and Tracking (TDT-2) corpus tagged as originating from the Associated Press's (AP) World Stream program due to its similarity to other news sources and information services of interest.

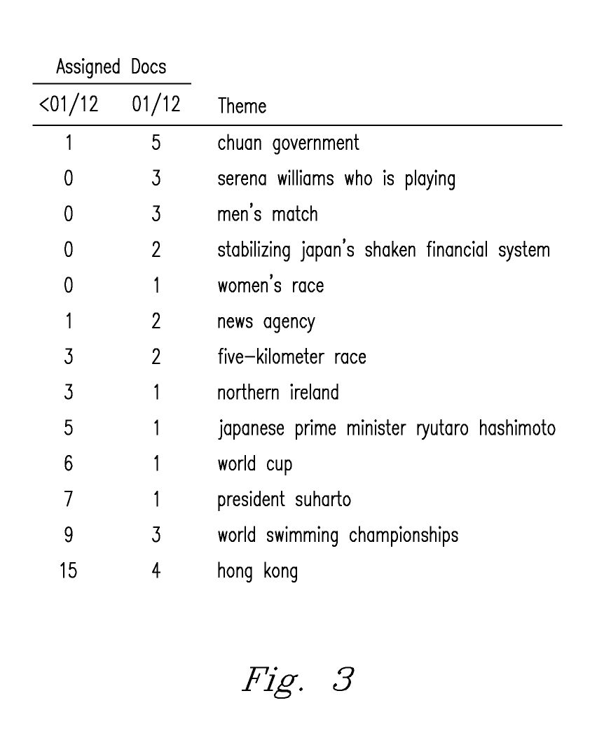

FIG. 3 lists the calculated themes on Jan. 12, 1998 for AP documents in the TDT-2 Corpus. The first column lists the count of documents assigned to each theme that were published before January 12. The second column lists each theme's count of documents that were published on January 12. Comparing these counts across themes allows us to easily identify which stories are new (e.g., chuan government, serena williams who is playing, men's match) and which stories are the largest (e.g., hong kong and world swimming championships).

Clusters, documents, themes, and/or stories can be represented visually according to embodiments of the present invention. Two such visual representations, which can provide greater insight into the characteristics of themes and stories in a temporal context, are described below.

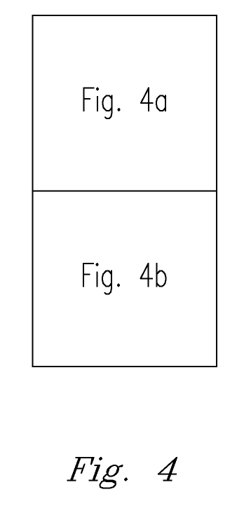

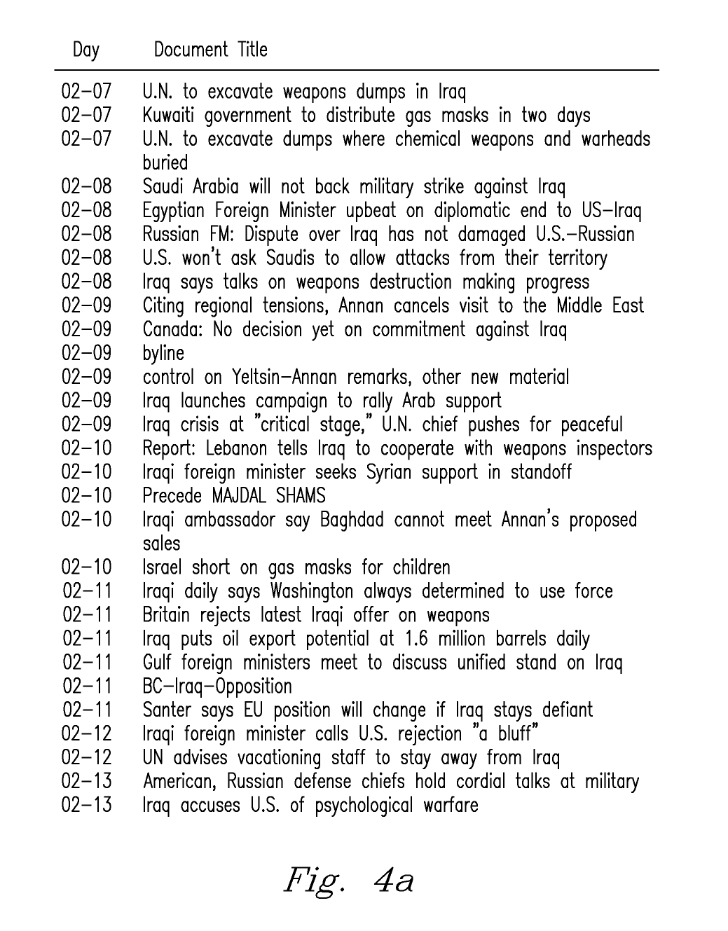

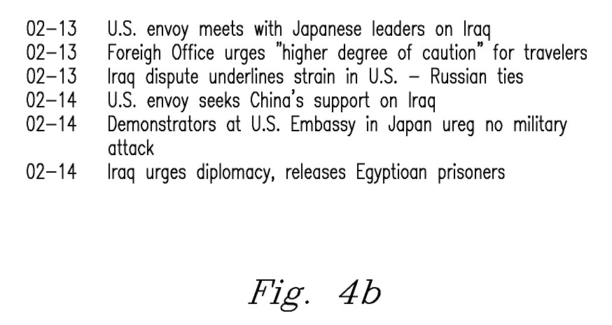

The first view, a portion of which is shown in FIG. 4, represents the current time interval and its themes. The view presents each theme as a listing of its member documents in ascending order by date. This view has the advantage of simplicity. An observer can easily assess the magnitude of each theme, its duration, and documents that have been added each day. However, lacking from this view is the larger temporal context and information on how related themes have changed and evolved over previous days.

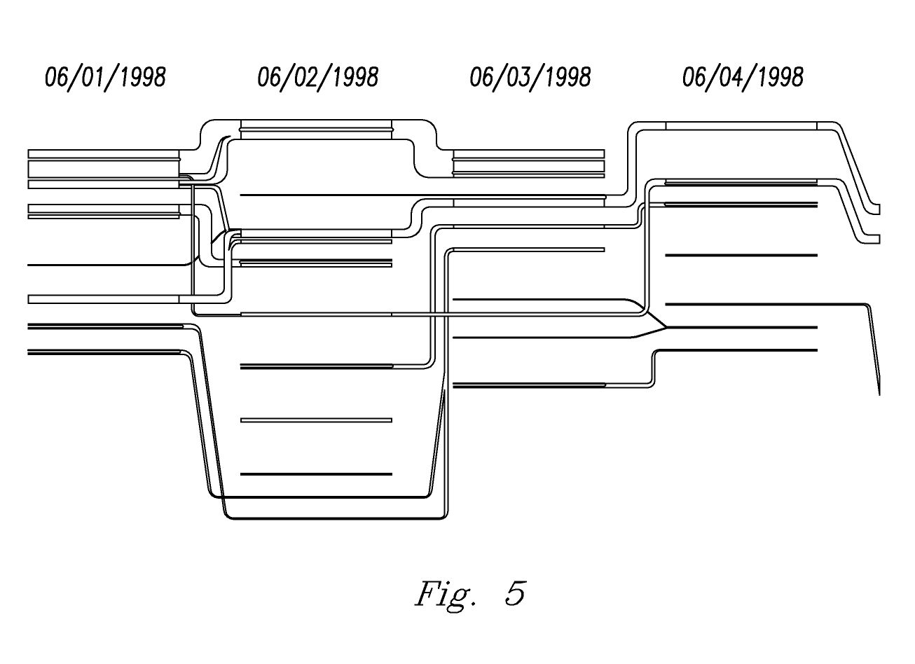

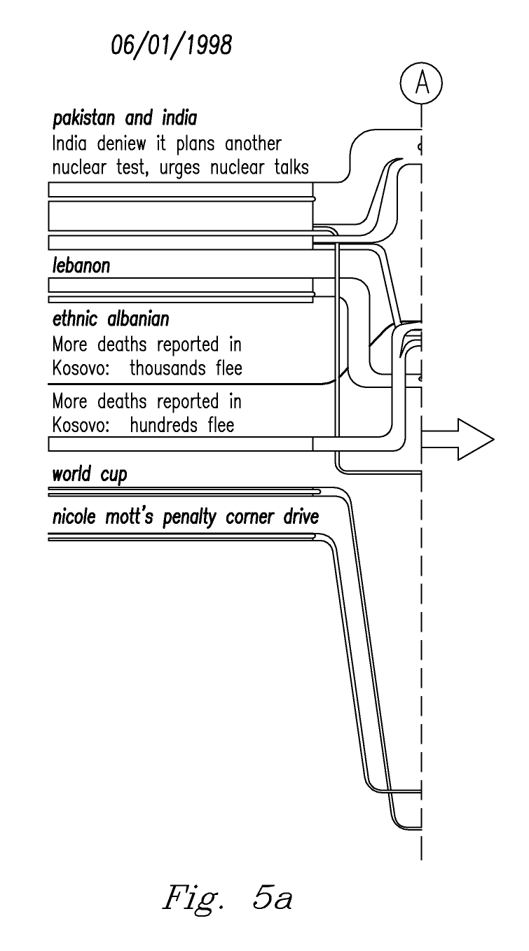

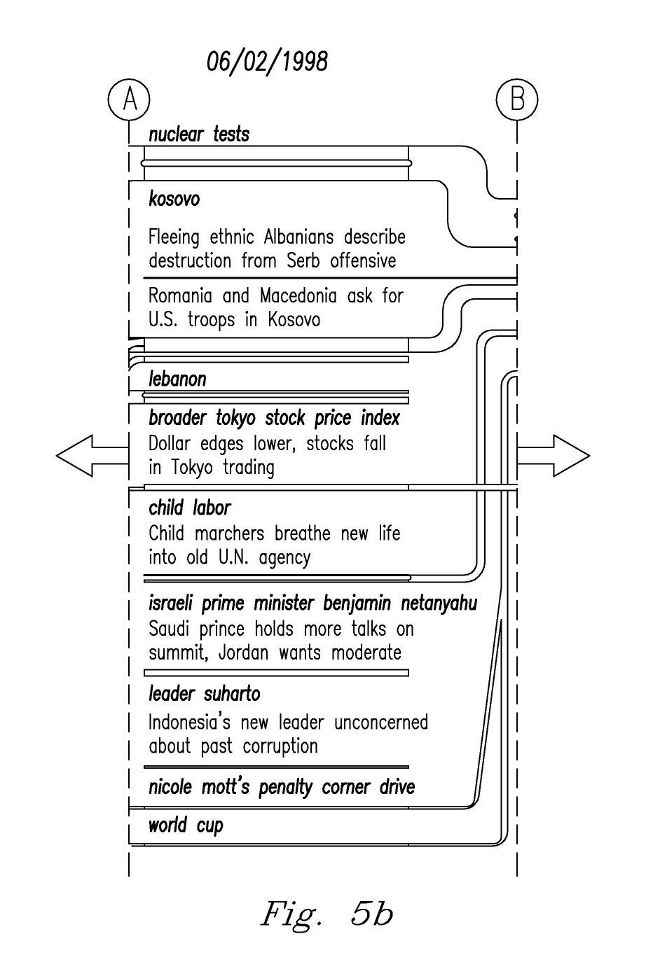

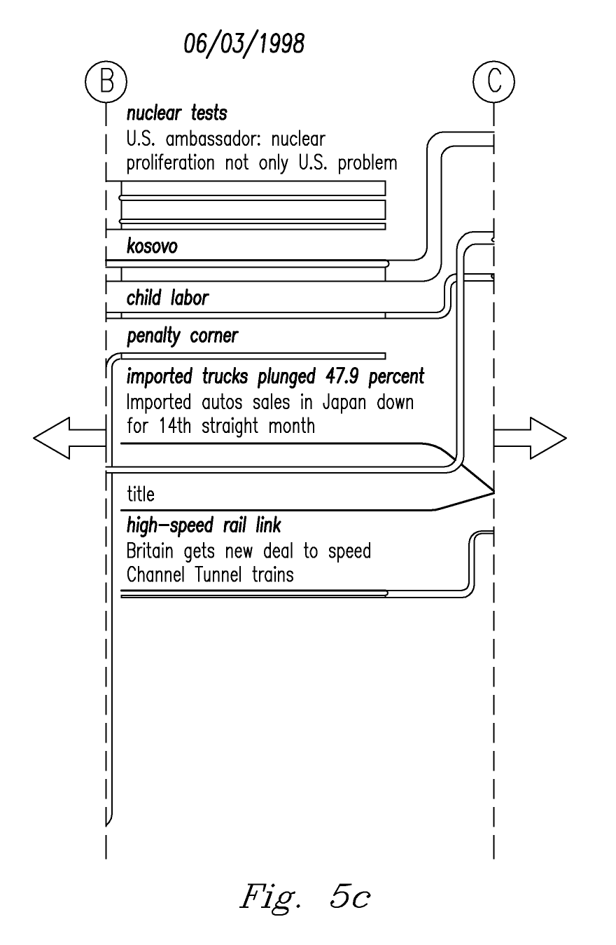

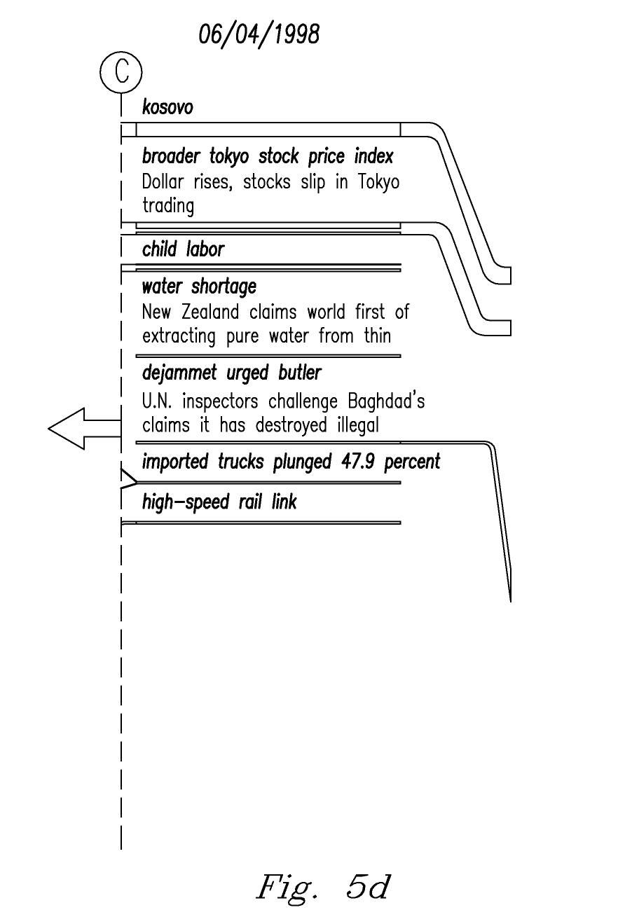

To provide a temporal context we developed the Story Flow Visualization (SFV). The Story Flow visualization, a portion of which is shown in FIG. 5, shows for a set of time intervals, the themes computed for those intervals, and their assigned documents which may link themes over time into stories. The visualization places time (e.g., days) across the horizontal axis and orders daily themes along the vertical axis by their assigned document count.

For a given interval, each theme is labeled with its top lexical unit in italics and lists its assigned documents in descending order by date. Each document is labeled with its title on the day that it is first published (or received), and rendered as a line connecting its positions across multiple days. This preserves space and reinforces the importance and time of each document, as the document title is only shown in one location. Similar lines across time intervals represent flows of documents assigned to the same themes, related to the same story. As stories grow over days, they add more lines. A document's line ends when it is no longer associated with any themes.

Referring to FIG. 5, which shows computed themes for four days of AP documents from the TDT-2 APW corpus, we can see that the top story for the first three days is initially labeled Pakistan and India but changes to nuclear tests on the following two days. The theme Pakistan and India loses two documents to other themes on the following day. These are likely documents that do not relate directly to the theme nuclear tests and therefore were assigned to other stories as the earlier theme Pakistan and India became more focused on nuclear tests. No documents published on June 2 are assigned to the nuclear tests theme. Another story that is moving up over the days begins as ethnic Albanians and quickly becomes labeled as Kosovo. Stories can skip days, as shown by the documents related to the broader Tokyo stock price index themes that appear on June 2 and June 4.

Some embodiments can order schemes that take into account relative positions of related groups across days in order to minimize line crossings at interval boundaries. However, consistently ordering themes for each interval by their number of assigned documents, as is done in the present embodiment, can help ensure that the theme order for each day is unaffected by future days. This preserves the organization of themes in the story flow visualization across days and supports information consumers' extended interaction over days and weeks. An individual or team would therefore be able to print out each day's story flow column with document titles and lines, and post that next to the previous day's columns. Such an approach would be unrestricted by monitor resolution and support interaction and collaboration through manual edits and notes on the paper hard copies. Each foot of wall space could hold up to seven daily columns, enabling a nine foot wall to hold two months worth of temporal context along a single horizontal span.

On a single high-resolution monitor, seven days can be rendered as each daily column can be allocated a width of 300 pixels which accommodates most document titles. Longer time periods can be made accessible through the application of a scrolling function.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented process for computation and analysis of significant themes within a corpus of documents, which is maintained in a storage device and/or streamed through communications hardware, the process comprising:
Providing a plurality of lexical units;
Generating a lexical unit document association (LUDA) vector for each lexical unit, wherein the LUDA vector characterizes a measure of association between its corresponding lexical unit and documents in the corpus;
Quantifying similarities between each unique pair of lexical units; and
Grouping the lexical units into clusters such that each cluster contains a set of lexical units that are most similar as determined by the LUDA vectors and a predetermined clustering threshold.

2. The process of claim 1, wherein the measures of association of each LUDA vector are determined by submitting the lexical unit as a query to a search index based on the corpus of documents and storing document responses to the query within the LUDA vector.

3. The process of claim 1, wherein the measures of association of each LUDA vector are determined by quantifying frequencies of the lexical unit within each document in the corpus and storing the frequencies within the LUDA vector.

4. The process of claim 1, wherein the measures of association of each LUDA vector are determined by tokenizing the lexical unit into individual words and quantifying a summation of frequencies of each word within each document in the corpus and storing the frequencies within the LUDA vector.

5. The process of claim 1, wherein similarities between lexical units are quantified using Sorensen similarity coefficients of their respective LUDA vectors.

6. The process of claim 1, wherein similarities between lexical units are quantified using Jaccard similarity coefficients of their respective LUDA vectors.

7. The process of claim 1, wherein similarity between lexical units is quantified using pointwise mutual information of their respective LUDA vectors.

8. The process of claim 1, further comprising assigning to each cluster a theme label comprising the lexical unit within each cluster having the greatest measure of association.

9. The process of claim 1, further comprising repeating said providing, generating, quantifying, and grouping steps at pre-defined time intervals if the corpus of documents is not static.

10. The process of claim 1, wherein said providing step comprises extracting lexical units from individual documents within the corpus of documents.

11. The process of claim 10, wherein said extracting comprises:
Parsing words in an individual document by delimiters, stop words, or both to identify candidate lexical units;
Determining co-occurrences of words within the candidate lexical units;
Calculating word scores for each word within the candidate lexical units based on a function of co-occurrence degree, co-occurrence frequency, or both;
Calculating a lexical unit score for each candidate lexical unit based on a function of word scores for words within the candidate lexical unit; and
Selecting a portion of the candidate lexical units to extract as lexical units based, at least in part, on the candidate lexical units with highest lexical unit scores.

12. The computer-implemented method of claim 11, further comprising storing the co-occurrences of words within a word co-occurrence graph.

13. The computer-implemented method of claim 11, wherein said calculating a lexical unit score for each candidate lexical unit comprises summing the word scores for each word within the candidate lexical units.

14. The computer-implemented method of claim 11, wherein said selecting comprises selecting a number, T, of the candidate lexical units having highest lexical unit scores to extract as lexical units.

15. The computer-implemented method of claim 11, further comprising identifying adjoining candidate lexical units that adjoin one another at least twice in the individual document and in the same order, and creating a new candidate lexical unit from the adjoining candidate lexical units and any interior stop words.

16. The computer-implemented process of claim 1, wherein similarities between lexical units are quantified using Sorensen similarity coefficients of respective LUDA vectors.

17. The computer-implemented process of claim 1, wherein similarity between lexical units is quantified using pointwise mutual information of respective LUDA vectors.

18. The computer-implemented process of claim 1, wherein said grouping comprises applying hierarchical agglomerative clustering to successively join similar pairs of lexical units into a hierarchy.

19. The computer-implemented process of claim 18, wherein the hierarchical clustering is Ward's hierarchical clustering, and clusters are defined using a coherence threshold of 0.65.

20. The computer-implemented process of claim 1, further comprising generating a story flow visualization comprising a representation of documents, themes, and stories in a temporal context.

21. A system for computation and analysis of significant themes with a corpus of documents, which is maintained in a storage device and/or streamed through communications hardware, the system comprising:
A storage device, a communications interface, an input device, or a combination thereof providing a plurality of lexical units;
A processor programmed to:
Generate a lexical unit document association (LUDA) vector for each lexical unit, wherein the LUDA vector characterizes a measure of association between its corresponding lexical unit and documents in the corpus;
Quantify similarities between each unique pair of lexical units; and
Group the lexical units into clusters such that each cluster contains a set of lexical units that are most similar as determined by the LUDA vectors and a predetermined clustering threshold.

22. The system of claim 21, wherein the processor is programmed to repeat the compute, generate, calculate, and group steps at pre-defined time intervals if the corpus of documents is not static.

23. The system of claim 21, wherein the process is programmed to assign to each cluster a theme label comprising the lexical unit within each cluster having the greatest measure of association.

24. The system of claim 21, wherein the plurality of lexical units is provided by a processor programmed to extract lexical units from individual documents within the corpus of documents.

25. The system of claim 21, wherein the processor is further programmed to:
Parse words in an individual document by delimiters, stop words, or both to identify candidate lexical units;
Determine co-occurrences of words within the candidate lexical units;
Calculate word scores for each word within the candidate lexical units based on a function of co-occurrence degree, co-occurrence frequency, or both;
Calculate a lexical unit score for each candidate lexical unit based on a function of word scores for words within the candidate lexical unit; and
Select a portion of the candidate lexical units to extract as lexical units based, at least in part, on the candidate lexical units with highest lexical unit scores.

26. The system of claim 25, wherein the processor is further programmed to store the co-occurrences of words within a word co-occurrence graph.

27. The system of claim 25, wherein the processor programmed to calculate a lexical unit score for each candidate lexical further comprises programming to sum the word scores for each word within the candidate lexical units.

28. The system of claim 25, wherein the processor is further programmed to identify adjoining candidate lexical units that adjoin one another at least twice in the individual document and in the same order, and to create a new candidate lexical unit from the adjoining candidate lexical units and any interior stop words.

29. The system of claim 21, wherein the processor further comprises programming to apply hierarchical agglomerative clustering to successively join similar pairs of lexical units into a hierarchy.

30. The system of claim 21, wherein the processor further comprises programming to generate on a display device a story flow visualization comprising a representation of documents, themes, and stories in a temporal context.
